(19) United States
(12) Patent Application Publication
(10) Pub. No.: US 2022/0086846 A1
(43) Pub. Date: Mar. 17, 2022

(54) LATENCY-AS-A-SERVICE (LAAS) PLATFORM

(71) Applicant: MOTOJEANNIE, INC., Santa Clara, CA (US)

(72) Inventor: Ayush SHARMA, Cupertino, CA (US)

(73) Assignee: MOTOJEANNIE, INC., Santa Clara, CA (US)

(21) Appl. No.: 17/379,674

(22) Filed: Jul. 19, 2021

Related U.S. Application Data
(60) Provisional application No. 63/077,361, filed on Sep. 11, 2020.

(51) Int. Cl. H04W 72/08; H04L 12/26; G06N 5/04

(52) U.S. Cl. CPC H04W 72/087; G06N 5/04; H04L 43/0864

(57) ABSTRACT

In accordance with the embodiments of this disclosure, a unified architecture comprising an infrastructure controller and a multi-edge computing (MEC) platform, is presented for handling latency-sensitive applications in a communication network. The infrastructure controller comprises a processor and a memory storing computer-executable instructions that when executed, cause the processor to receive real-time information related to one or more applications deployed on the MEC platform in the communication network. The computer-executable instructions further cause the processor to control one or more infrastructure components of the communication network based on the received real-time information.

### CROSS REFERENCE TO RELATED APPLICATIONS

This application claims the benefit of U.S. Provisional Patent Application Ser. No. 63/077,361, titled “Latency-As-A-Service (LaaS) Platform”, filed on Sep. 11, 2020, which is assigned to the assignee hereof and hereby, expressly incorporated by reference herein.

### FIELD OF THE INVENTION

The present invention is generally directed towards systems and methods for use in cellular communication networks and Wireless Fidelity (Wi-Fi) communication networks. More particularly, the present invention relates to a Latency-as-a-Service™ (LaaS) platform in 5^{th} Generation (5G) communication networks and wireless fidelity (Wi-Fi) 6 communication networks.

### BACKGROUND OF THE INVENTION

With the recent advancement of telecommunication technology and communication infrastructure, the amount of network and data traffic through 5G networks, is expected to be very high compared to previous generation of networks. For instance, the 5G networks are designed to provide revolutionary and seamless connectivity. The backbone of the 5G wireless connectivity is realized with a robust network architecture that aims at laying the foundation for applications requiring low latency and reliable network capacity. One of the key features of the 5G network architecture is the disaggregation of typical network functions. This disaggregation enables moving some of the network functions closer to the end user equipment, also referred to as “Edge”. The future applications that will be serviced by the 5G networks may require ultra-reliable communication capabilities and lower latencies. Such requirements of the next-generation applications may increase the implementation complexity at the Edge. The management of such a data rich communication network at the Edge within the 5G architectural guidelines creates a suboptimal scenario, which may potentially curtail the user experience and consequentially, the productivity of the next generation applications.

### SUMMARY OF THE INVENTION

Embodiments of a method, a computer-readable medium, and a corresponding system for implementing Latency-as-a-Service (LaaS) are disclosed. In an embodiment, the system may include a seamless and comprehensive integration of a Radio Access Network Intelligent Controller (RIC) architecture and a Multi-access Edge Computing (MEC) architecture.

In accordance with an embodiment, a method for handling latency-sensitive applications in a communication network, is disclosed. The method includes receiving real-time information related to one or more applications deployed on a multi-edge computing (MEC) platform in the communication network. The method further includes controlling one or more infrastructure components of the communication network based on the received real-time information.

### BRIEF DESCRIPTION OF THE DRAWINGS

Further advantages of the invention will become apparent by reference to the detailed description of preferred embodiments when considered in conjunction with the drawings:

FIG. 1 depicts a Radio Access Network Intelligent Controller (RIC) architecture, in accordance with an embodiment.

FIG. 2 depicts an embodiment of a MEC architecture, in accordance with an embodiment.

FIG. 3 depicts an exemplary operating environment in which an LaaS system may be utilized, in accordance with an embodiment.

FIG. 4 depicts an exemplary LaaS architecture in accordance with an embodiment.

FIG. 5 depicts internal components of an exemplary LaaS system, in accordance with an embodiment.

FIG. 6 depicts a high-level illustration of a communication network, in accordance with an embodiment.

FIG. 7 depicts a detailed illustration of the communication network, in accordance with an embodiment.

FIG. 8 illustrates a flowchart for utilizing a unified architecture in accordance with an embodiment.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown but is to be accorded the widest possible scope consistent with the principles and features disclosed herein.

Certain terms and phrases have been used throughout the disclosure and will have the following meanings in the context of the ongoing disclosure. For purposes of explanation, an “MEC orchestrator” may be responsible for overall control of the network resource management in the communication network. Additionally, in some embodiments, the “MEC orchestrator” along with an “MEC platform”, as disclosed in further sections of the disclosure, may collectively be referred to as “Edge-X™”. The Edge-X™ may, however, include one or more additional components that may be included in an edge-site, as described later in this disclosure. Further, the terms “edge site” and “Edge-X™” are used interchangeably throughout the disclosure and may be hosted on an Edge-based public cloud. In an exemplary scenario, the edge site may include a central office to manage operations of the edge site, a MEC orchestrator to deploy applications, a MEC platform on which the latency-sensitive applications are deployed, a MEC platform manager to manage the MEC platform, and a virtual infrastructure manager (not shown) to manage virtual infrastructure.

Here, the terms “MEC host” and “MEC platform” are used interchangeably in the disclosure. The MEC host may refer to the physical infrastructure (e.g. servers, processors, memory devices and so on) that hosts the MEC platform. In some embodiments, the MEC host may include a data plane, the MEC platform and one or more MEC applications that are deployed on the MEC platform by a MEC platform manager. The overall task of the MEC host is to collect data, either the data traffic via data plane or specific data for deployed applications. Once data is transferred to the deployed applications, the MEC host may perform the required processing and send the data back to a respective source of data.

In one example, there are two sets of applications included in the MEC applications. One set of applications is referred to as consumer applications that consume data/traffic from the MEC host. This data/traffic may be related to an end user, for instance. For example, Virtual Reality (VR) Video Streaming, Cloud gaming, VR Conferencing etc. are consumer applications. The other set of applications is referred to as network applications or producer applications that produce some data for the consumer applications. For example, Virtual Firewall (vFW), Domain Name System (DNS), Location Services, Radio Network Information etc. are producer applications. These applications provide services to the consumer applications.

Further, a User Equipment (UE) may implement a software-based platform called “Lounge-X™” to run one or more applications that may transmit traffic or data to the MEC platform, in accordance with the embodiments of this disclosure. The “Lounge-X™” platform may be adapted to be implemented on any type of UE such as, but not limited to, a smartphone, a tablet, a phablet, a laptop, a desktop, a smartwatch, a smartphone mirrored on a television (TV), a smart TV, a drone, an AR/VR device, a camera recording an event in a stadium, a sports equipment with on-board sensors, or a similar device that is capable of being operated by the user, in the communication network. Further, the applications may be, but not limited to, an (augmented reality) AR/(virtual reality) VR based meditation application, an AR/VR based gaming application, an AR/VR streaming application, an Industrial Internet of Things (IIoTs) based application, a connected cars application, a cloud gaming application or a holographic view application. Further, Lounge-X™ can be installed on any Android®, iOS®, Unity™-based devices, or any other mobile operating system. Further, an input provided by a user via “Lounge-X™” to select on the applications on the UE may be, but not limited to, a touch input or gesture, a voice command, an air gesture, or an input provided via an electronic device such as, but not limited to, a stylus, keyboard, mouse and so on.

The “Lounge-X™” may represent UE-side components while “Edge-X™” may represent network-side components. This implies that a network instance of each application that runs on the UE using the “Lounge-X™” platform, may be deployed on the “Edge-X™” platform, at the network side. Both “Edge-X™” and “Lounge-X™” may be in communication with each other through a “control loop” mechanism. In one example, the “control loop” may not necessarily be a physical entity but a virtual or logical connection, via which, at least some functions of the “Lounge-X™” may be managed by “Edge-X™”. In another example, the “control loop” may be a feedback mechanism between the Lounge-X™ at one end and Edge-X™ and Cloud-X™ at the other end. Here, the term “Cloud-X™” may include a proprietary or third-party cloud service for storing one or more of, but not limited to, data planes, control planes/functions, and 5G core network components. In an embodiment, “Lounge-X™” constantly monitors and manages the user experience by communicating the resource needs of a resource-intensive and/or latency sensitive application to “Edge-X™” through the “control loop”. The embodiments of this disclosure enable such applications on the UE to seamlessly run and enhance the user experience without any incumbrances to the user in watching the streamed content. In some embodiments, the “Edge-X™” and “Lounge-X™” may collectively be called as “X-Factor™”, which may be deployed on the MEC platform.

Here, the control loop may additionally facilitate communication of user/UE related data such as user/UE location, applications selected by the user, and/or content preferences of the user to the Edge-X™, which may further communicate it to a RIC architecture-based infrastructure controller, in accordance with the embodiments of this disclosure. The infrastructure controller may then take intelligent decisions on controlling network components based on such user/UE related data and/or real-time information related to network behavior when the selected applications are deployed in the network.

The UE may communicate the network via any known communication technology, such as a cellular telephone network, a wireless local area network (LAN) and/or a metropolitan area network (MAN). The wireless communication may use any of a plurality of communication standards, protocols and technologies, such as Long Term Evolution (LTE), LTE-Advanced, Global System for Mobile Communications (GSM), Enhanced Data GSM Environment (EDGE), wideband code division multiple access (W-CDMA), code division multiple access (CDMA), time division multiple access (TDMA), Single-Carrier Frequency Division Multiple Access (SC-FDMA), Orthogonal Frequency Division Multiple Access (OFDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The above terms and definitions are provided merely to assist a reader in understanding the disclosed embodiments in a better manner and do not limit the scope of any functionality, feature, or description herein.

Additionally, the terms “architecture” and “architectural framework” are interchangeably used throughout this disclosure. Further, the terms “communication network”, “communication networks”, “networks”, and “network” are used interchangeably for brevity. Further, the term “resource” or “resources” may encompass one or more of, but not limited to, resources related to latency requirements, computation requirements, connectivity requirements, frequency, time, bandwidth, data rate or throughput, connection interface requirements, graphic or display capabilities and storage requirements. In one example, the resources may encompass one or more of, but not limited to, resources related to 3 C's of Next Generation network communication—Content, Compute, and Connectivity. Here, Content-based resources may include content delivery networks (CDNs) for providing content to a user using the UE. Further, Compute-based resources may include an edge-based infrastructure (e.g. Edge-X™) that may be used in the network to increase compute flexibility of the network. Additionally, Connectivity-based resources may include network slicing, which may be used for seamless connectivity between the user and the network. Additionally, the network resources may also include frequency, time, bandwidth, data rate or throughput, processing power requirements, connection interface requirements, graphic and/or display capabilities, and storage requirements.

Further, the requirements of 5G network supported applications disclosed in the embodiments of this disclosure, may be higher as compared to conventional networks or technologies and may accordingly, be satisfied by the disclosed embodiments. Further, the disclosed approaches are directed towards resource intensive applications that are dependent on ultra-low latency in 5G networks. As a consequence of the disclosed embodiments and a unified architecture presented herein, the user experience is expected to be immersive, fluid, and dynamic.

Due to ever increasing demand for network resources, a lot of research is being undertaken for optimized utilization of network resources. Edge computing and pushing typical network functions to Edge has been a successful approach in this direction. However, there still are some disadvantages and shortcomings in the existing approaches related to Edge computing. Some of the potential shortcomings at the Edge may be addressed by creating open interfaces at several layers, and with the use of Artificial Intelligence (AI) for network management and operations. Such approaches can streamline the network management and performance issues, but still lack a holistic view of network resources needed by a particular application and associated optimizations based on Quality of Experience (QoE) metrics. In recent times, telecommunication service providers that have invested in providing 5G network services have optimized their networks for mobility applications. However, typical enterprise connectivity includes private networks and operator-provided networks using a combination of wired and wireless networks and requires addressing the performance and data localization requirements at or of the Edge.

Latency is an important consideration in implementing Edge computing in the 5G networks. Latency, in one example, may refer to a delay between an end user executing an action on an application on a user equipment (UE) in a network and the UE receiving a response from the network. To optimize a network, it is desirable to minimize the latency in the network. Edge computing minimizes the latency by reducing the response time from the network. This is because the data packets from the UE do not need to traverse to the cloud but instead, to an edge site that is located closer to the end user by being positioned between the cloud and the end user. Herein, the terms ‘end user’ and ‘user’ are interchangeably used throughout the disclosure.

Latency can be caused by various factors. For instance, ‘network latency’ describes a delay that takes place during communication over a network. In existing solutions, the time it takes to move data packets to the cloud, perform a service on it at the cloud, and then move it back to the UE is far too long to meet the increasing needs of low latency applications like Audio-visual (AV) services, Emergency services etc. In 4G LTE networks, round trip latency ranges between 60-70 milliseconds (ms). With 5G speeds, the latency can be reduced to the range of <10 ms.

Another factor that contributes to latency for enterprise applications includes “compute latency”. Latency in compute can be defined as the delay between a user's action and a web application's response to that action. Processing time represents another critical factor in the total service time. Virtualization overhead may incur increased processing time and associated variability. To address this problem, enterprises use solutions such as applications using bare metal server, which reduces overheads in processing. Computing performance can be further improved when a latency-sensitivity feature is used together with a pass-through mechanism, such as, Single-Root Input/Output Virtualization (SR-IOV). Edge computing reduces the processing time and delivers faster and more responsive services by locating key processing tasks closer to end users. Data is being processed at the Edge rather than getting sent to the Data center which is multiple hops away.

In case of storage subsystems, latency refers to how long it takes for a single data request to be received and the correct data to be found and accessed from the storage media. The cost reduction and recent advancements in flash storage technologies have improved its adoption and enabled reduction in the application latency.

Web traffic and streaming services also suffer from latency issues, as discussed above. For static content, Content Delivery Networks (CDNs) mitigate the latency issues by distributing the content closer to the users and thus, reducing the number of hops between the users. Therefore, traditional network vendors have evolved from traditional routing to Software Defined/Content Delivery Networking (SDN/CDN) to intent-based routing.

The potential network traffic routing paths offer different performance and availability characteristics, and the selection of a routing path is based on how they meet the needs of specific applications by identifying them and their current states. The focus in existing solutions is primarily on the orchestration, translation, and assurance of services. Several criteria can be considered for dynamic path selection, but the current focus and ongoing discussion on latency, loss, and jitter measurements are fundamental to ensure that the business intent of these applications is satisfied.

As applications become experience intensive and content rich, the need for bringing content and compute closer to the user (or Edge) is being realized by virtualization of network functions. Current Edge platforms that provide application framework for Edge applications, focus on the orchestration and lifecycle management of the infrastructure. Such platforms provide application framework for hosting Edge applications, which manage only compute and storage latency to a large extent.

Existing Edge solutions, however, lack visibility into physical access networks such as Wi-Fi 6, Long Term Evolution (LTE)—4G, 5G and so on, and corresponding resources to effectively reduce network latency. Further, there is a lack of visibility on the user experience and no feedback loop is available for changes in “Network/Compute/Storage” resources as per the application needs, which results in a suboptimal user experience.

Additionally, current Edge platforms have training and inference at the “cloud” to make the applications more intelligent. However, there is no closed loop feedback of Network, Compute and User experience considered at the “Edge” to make the inference model meaningful. Therefore, bringing higher intelligence to the Edge where the data is generated in order to provide predictive and proactive models is critical. Implementing the data pipeline for inference (while training the model at the “cloud”) for both access networks (RIC) and compute resources (MEC) is important to address service level end-to-end latency.

Further, Edge platforms should have the capability to manage, orchestrate, control all the following cohesively at the “Edge” to fulfill the needs of end-to-end service low latency use cases: a) Edge Computing Support & Capabilities; b) Connectivity, Networks & Communications; and c) Experience, Track, & Record, etc.

The critical capabilities of a MEC platform include the capability to be access network agnostic i.e., agnostic to types of networks such as Long-Term Evolution (LTE), Next Generation-Radio Access Network (NG-RAN), Wi-Fi, Wired Networks and so on. The MEC platform further includes the ability for applications to publish their presence and capabilities on the platform, and for other applications to subscribe to those services. In addition, the MEC platform should also include a hardware agnostic scalable architecture, such as, OpenvSwitch-Data Plane Development Kit (OVS-DPDK), a high-level platform-agnostic programming language (e.g. P4), SRIOV and so on. Furthermore, the MEC platform should provide Application Program Interfaces (APIs) to allow the MEC orchestrator or a MEC controller to configure the traffic routing policy in the data-plane. Further, the MEC platform should be capable of handling traffic either directly from the Radio Access Network (RAN) nodes or over network-Edge interfaces such as, SGi interface between a packet data network (PDN) and a PDN gateway (PDN GW). In addition, the MEC platform should be capable of hosting multiple public or private cloud applications on the same nodes/cluster and should be able to provide inference at the Edge itself. Lastly, the MEC platform should provide for “Edge” to “Cloud” connectivity.

Existing solutions are segregated and employ a piece-meal approach. For instance, MEC platform provides a distributed computing environment for application and service hosting but focusses on life cycle management and orchestration/abstraction of the hardware for applications to run. On the other hand, RIC platform components, such as, radio information database and open control plane interfaces for mobility management, spectrum management, load balancing, radio resource control and RAN slicing are run in isolation and standardized interfaces are provided to access these.

Further, in case of live streaming, computation capability and network latency characteristics of the chosen nodes for the transcoding, packaging, and delivery of live video have a strong impact on the QoE perceived by the users. Cloud as well performs poorly since the network latency is highly disruptive in the live streaming scenario. Edge platform reduces considerable network delays with respect to the other deployment solutions. As the workload increases, hybrid (Edge with Cloud) approach tends to offload more applications to the Cloud, which incurs higher average network delay. Further, CDN is not the best solution for latency-sensitive applications when there is a need for processing power (e.g., video encoding). Yet, it remains a valid solution in other scenarios, for example, if only videos with the same characteristics (bitrate, etc.) are present as in offline streaming.

In existing solutions, most of the intelligent decisions are made at the Cloud. The inferencing, analytics and policy decisions are unaware of Edge access and/or operations of the MEC platform. Consequently, these functions are running independently and not cohesively to address the needs of next generation Edge scenarios and low latency use-cases. For instance, when the RIC platform sends any data, the MEC platform is unaware about services running on RAN nodes. Similarly, when MEC platform sends any data, the RIC platform is unaware about the services running on the MEC platform. As a result, there may be a lag in provisioning the services due to independent execution of the services on the RIC and MEC platforms.

Edge computing can provide a path not just to accelerate and simplify data processing but also to provide much needed insights where and when needed. Therefore, bringing inference at the Edge rather than at the Cloud, using the unified architecture as described in this disclosure, provides real-time responsiveness for critical low latency applications. Latency due to the queuing and processing operations are critical parameters when the deployment of Edge modules (e.g. RIC, Inference, Data caching, and Edge Compute) are segregated.

The disclosed embodiments herein provide solutions to at least the above-mentioned problems. In some embodiments, an infrastructure controller for handling latency-sensitive applications, is disclosed. The infrastructure controller includes at least a processor and a memory. The memory stores computer-executable instructions that when executed, cause the processor to receive a real-time information related to one or more applications deployed on a MEC platform in the communication network. Further, the computer-executable instructions cause the processor to control one or more infrastructure components of the communication network based on the received real-time information. Here, the one or more applications are selected in response to a user input received by a user equipment (UE) connected to the communication network.

In the above-described embodiments, the computer-executable instructions further cause the processor to determine one or more machine learning (ML) algorithms to be applied on the received real-time information to derive one or more artificial intelligence (AI) inferences. The one or more AI inferences include one or more actions to control the one or more infrastructure components of the communication network based on the received real-time information. Further, the computer-executable instructions further cause the processor to receive a UE related data. The computer-executable instructions further cause the processor to select one of the one or more actions based on one or more of the received UE related data, received real-time information, and requirements of the communication network to deploy the one or more applications. The computer-executable instructions further cause the processor to send a control signal to the one or more infrastructure components to control the one or more infrastructure components based on the selected one or more actions.

In the above-described embodiments, the infrastructure controller further includes a low latency bus to support communication between the MEC platform and the infrastructure controller in the apparatus to achieve a predetermined end-to-end latency for each application being executed on a UE connected to the communication network. Here, the infrastructure controller and the MEC platform are located on an edge-site in the communication network.

Further, in these embodiments, the real-time information includes one or more of a flow information and a network state information. In these embodiments, the computer-executable instructions further cause the processor to store the real-time information in the memory.

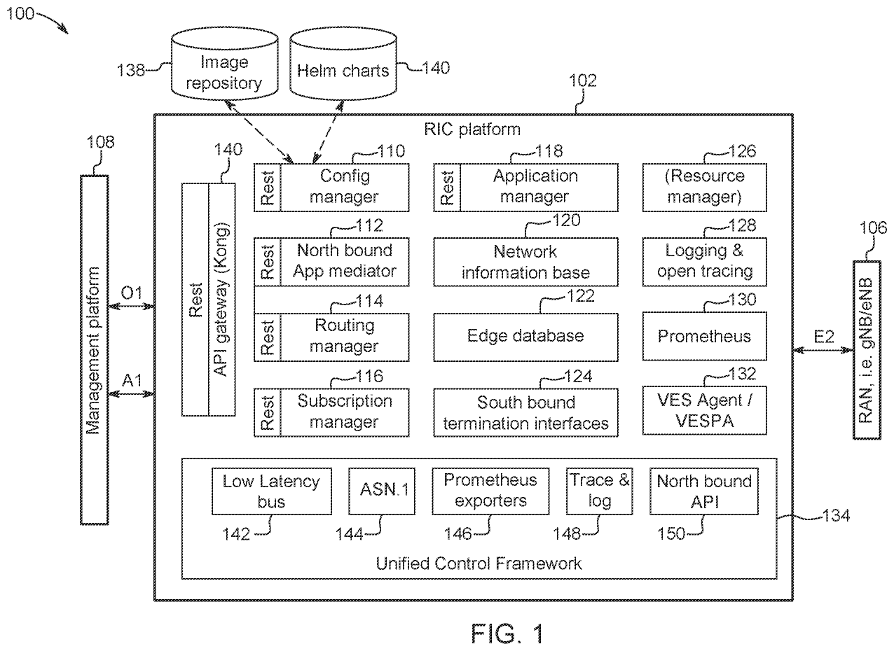

These and other embodiments of the methods and systems are described in more detail with reference to FIGS. 1-8, as follows.

FIG. 1 depicts a RIC architecture 100 in accordance with the embodiments of this disclosure. This RIC architecture 100 is in accordance with specifications by the Open-Radio Access Network (ORAN) Community, and may include an RIC platform 102. The RIC platform 102 may communicate with RAN nodes 106 via an E2 interface, which enables a RAN closed loop. In one example, the RAN closed loop may imply that the RIC platform 102 may obtain telemetry data regarding a condition of RAN nodes from the RAN nodes via the E2 interface. For instance, the condition of the RAN nodes may include real-time network state information regarding such as, but not limited to, a jitter, a throughput, an available bandwidth, a number of nodes connected to each RAN node, available computational resources, and so on. This condition may represent, at any time instant, a real time behavior of the RAN nodes when a resource-intensive application may be deployed in a network that includes these RAN nodes. This may enable an infrastructure controller associated with the RIC architecture 100 to control the RAN nodes by drawing intelligent inferences and decisions based on the condition of the RAN nodes, as will be described later in this disclosure.

Further, the RIC architecture 100 communicates with the Management platform 108, via an A1 interface and an O1 interface. The A1 interface is an intent based interface between near-real time RIC and non-real time RIC, and the O1 interface is responsible for data collection and control. The RIC architecture 100 may also include a Unified Control Framework 134. The Unified Control Framework 134 may further include a low latency bus 142, Abstract Syntax Notation one (ASN.1) 144, Prometheus exporters 146, Trace and log 148, and Northbound application package interface (API) 150. The functions of the above-mentioned components are described in the ORAN specifications and are not included here for brevity.

The RIC platform 102 may include one or more microservices that communicate with the RAN nodes 106 via subscribe-publish mechanism over the E2 interface. For example, these microservices may include a Config Manager 110 connected to an image repository 138 and a Helm charts module 140, Northbound Application (App) Mediator 112, Routing Manager 114, Subscription Manager 116, Application Manager 118, network information base (NIB) 120, edge database 122, Southbound Termination Interfaces 124, Resource Manager 126, Logging and OpenTracing 128, Prometheus 130, and VES Agent/VESPA 132, as known in the art. The one or more microservices communicate with each other using RIC Message Routing (RMR)/Kafka. Herein, RMR is a library which enables latency-sensitive applications to communicate with each other and Kafka is an open-source framework for analysis of streaming data associated with such applications.

Further, the management platform 108 may include a framework for service management and orchestration, which may include modules for design, inventory, policy, configuration, and non-real time RIC. The non-real time RIC supports non-real time radio resource management, policy optimization, and AI/ML models.

In an embodiment, the RIC architecture 100 may present multiple use cases, such as but not limited to, policy enforcement, handover optimization, radio-link management, load balancing, slicing policy, advanced self-organizing network, along with AI/ML programmability.

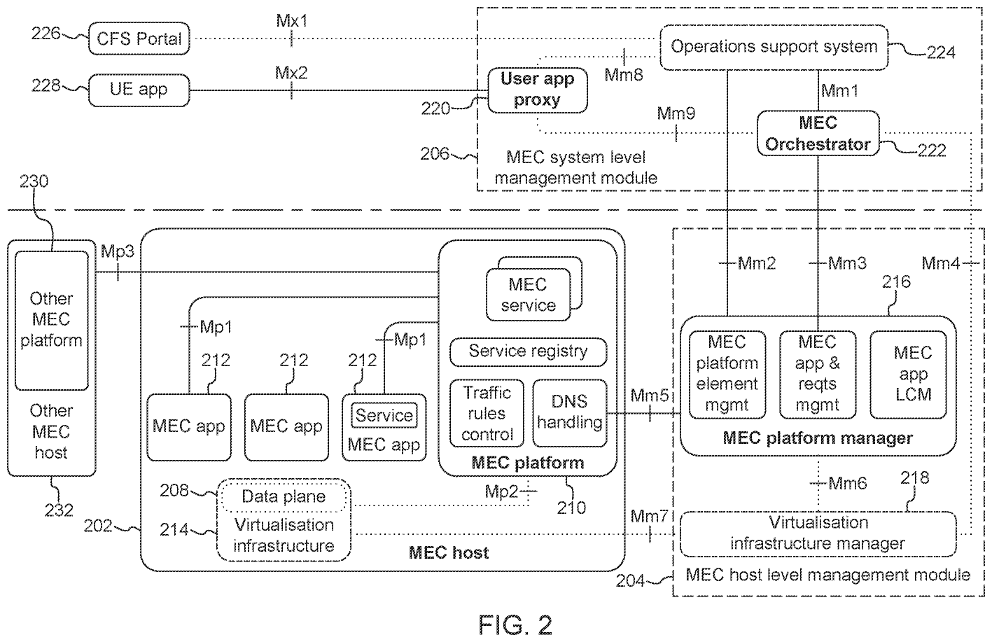

FIG. 2 depicts a Multi-access Edge Computing (MEC) architecture 200 in accordance with an embodiment of this disclosure. The MEC architecture 200 may be responsible for system level management and orchestration of a network. As illustrated, the MEC architecture 200 may be divided into three main sections namely, MEC host 202, MEC host level management module 204, and MEC system level management module 206.

At a high level, the MEC host 202 may include a data plane 208, an MEC Platform 210, and one or more MEC applications 212 that are deployed on the MEC host 202. The MEC host 202 may be included on an Edge-based cloud and may be part of an edge site that may include the MEC host 202, the MEC host level management module 204, and the MEC system level management module 206. In some other embodiments, however, MEC host may alone be included on an edge-based cloud and the remaining entities on the edge-site may be included in a separate cloud located farther from a UE accessing the edge site.

In one example, the traffic associated with the MEC applications 212 deployed on the MEC host 202, enters the MEC architectural framework 200 via the data plane 208 of the MEC host 202. The data plane 208 then sends the traffic to the MEC Platform 210 via an Mp2 interface. In the MEC platform 210, an appropriate application or service further routes the traffic to a required destination, such as the one or more MEC applications 212 with which the traffic is associated. Herein, the MEC platform 210 may include various functions such as a MEC service, a service register, a traffic rules control module and a domain name system (DNS) handling function. The MEC platform 210 may be in communication with the one or more MEC applications 212 via an Mp1 interface.

Additionally, the MEC host level management module 204 may include a virtualization infrastructure manager 218 that may manage a virtualization infrastructure 214 to deploy the MEC applications 212 on the MEC host. The MEC host level management module 204 may be in communication with the MEC system level management module 206. The MEC system level management module 206 may include an operations support system 224 connected to a user application (app) proxy 220 via an Mm8 interface and the MEC orchestrator 222 via an Mm1 interface. The MEC orchestrator 222 may be connected to the user app proxy 220 via an Mm9 interface. The functions of the operations support system 224 and user app proxy 220 may be as known in the art.

In one example, the user app proxy 220 may receive a request from a user equipment (UE) 228 indicating an application that is selected by a user on the UE 228. The user app proxy 220 may communicate the application details to the MEC orchestrator 222, which may determine a suitable deployment template for the application to be deployed in the MEC host 202. Here, the MEC host 202 and the MEC platform 210 are depicted as separate entities only for illustrative purposes. However, they may function as a single entity and their names can be interchangeably used.

For the purposes of explanation, it is not necessary that there is only one MEC host and/or MEC platform. There can be other MEC hosts and/or MEC platforms depending on design requirements such as a MEC platform 230 and a MEC host 232.

In accordance with the embodiments of this disclosure, the functioning of both RIC architecture 100 as explained above in FIG. 1 and MEC architecture 200 as explained in FIG. 2 can be analyzed. It may be concluded that both the RIC architecture 100 and the MEC architectural framework 200 perform similar tasks. For example, these tasks may include collecting data via the respective platform, processing the collected data, and sending the data to the respective application which is interfaced to the respective platform.

With reference to Edge-based deployments, both RIC architecture 100 and MEC architecture 200 may be present in the Edge location or Edge site. The edge site may either be located on-premises where the end user is located or in a separate central office that may be remotely located to the end user. The functioning of both RIC architecture 100 and the MEC architecture 200 may be modified and seamlessly combined to form a new unified architecture which can support both RIC and MEC types of applications. Further, such a combined or unified architecture may not necessarily require two different frameworks (RIC and MEC) to function independently or in isolation. The disclosed embodiments of unified architecture and LaaS architecture are designed based on this fundamental premise.

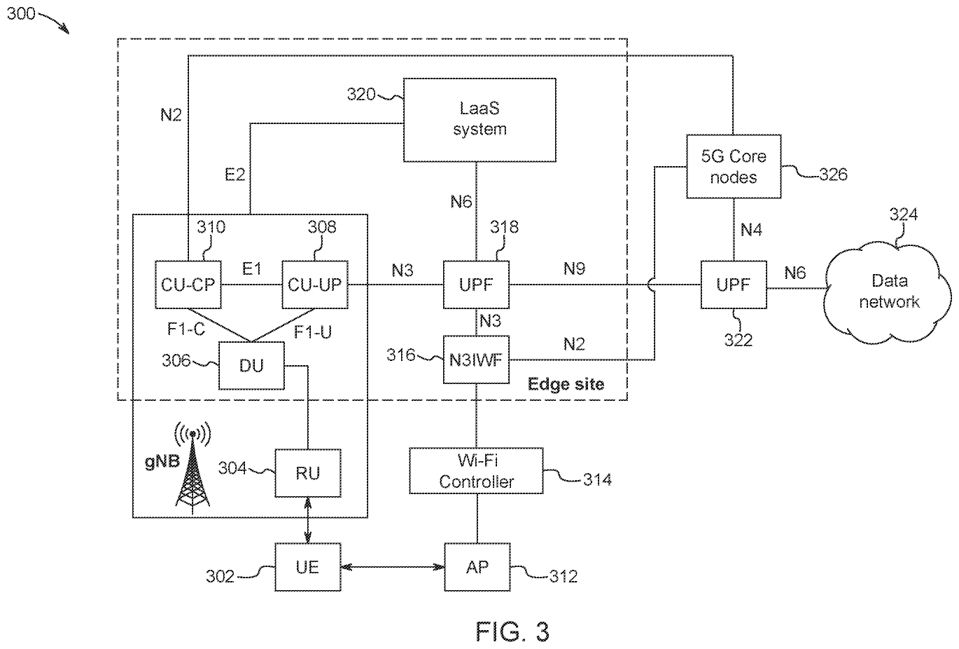

FIG. 3 depicts an exemplary operating environment in which a LaaS system 320 may be utilized in accordance with the embodiments of this disclosure. As depicted, the exemplary operating environment may be a communication network 300, in some embodiments of this disclosure. The communication network 300 may include a user equipment (UE) 302 that at least includes a Lounge-X™ platform or application, a Radio Unit (RU) 304, a distributed unit (DU) 306, a central unit—user plane (CU-UP) 308, a central unit—control plane (CU-CP) 310, an access point (AP) 312, a Wi-Fi controller 314, a Non-3GPP Inter Working Function (N3IWF) 316, a user plane function (UPF) 318, a LaaS system 320, a UPF 322, a data network 324, and one or more 5G core nodes 326. In accordance with an embodiment, the LaaS system 320 may include a unified architecture that may include the RIC architecture 100 as well as the MEC architecture 200 with the objective that the unified architecture is able to service all applications supported by RIC architecture 100 as well as the MEC architecture 200.

In accordance with the embodiments of this disclosure, the RIC architecture 100 may be implemented on an infrastructure controller, which may be hosted on an Edge-based public cloud. The infrastructure controller may be in communication with a MEC platform that is also hosted on the Edge-based public cloud to form an Edge-based unified architecture, in accordance with the embodiments of this disclosure. As a consequence of this unified architecture and bringing the RIC functionalities closer to the UE (on the Edge), Artificial Intelligence (AI)-based inferencing may be done on the Edge (Edge-based cloud), which reduces latency in the network.

In an exemplary scenario, when a user uses the Lounge-X™ platform on the UE 302 to select and execute an application, the latency in servicing this execution is reduced because both the RIC architecture 100 and the MEC architecture 200 are now located in an edge site (or Edge-X™). The edge site is closer to the location of the user as opposed to existing solutions where one or both of these components could be located in a cloud farther from the UE and the Edge, which causes higher latency.

In accordance with the embodiments of this disclosure, the UE 302 may access a 5G network such as the communication network 300, by connecting through the RU 304. The RU 304 communicates with the DU 306, which further communicates with the CU-UP 308 and the CU-CP 310 via F1-u and F1-c interfaces, respectively. The CU-CP 310 communicates with the one or more 5G core nodes 326 at one end via an N2 interface and the CU-UP 308 at the other end via an E1 interface. The CU-UP 308 communicates with the UPF 318 via an N3 interface. As shown by dotted lines in FIG. 3, gNB includes the RU 304, DU 306, and CU divided as CU-UP 308, and CU-CP 310. For sake of brevity, gNB has been exemplified in FIG. 3. However, it may be apparent to a person skilled in the art that RAN node may be replaced with an eNB to utilize the functionality of LaaS system 320.

In another embodiment, the UE 302 may additionally communicate with an AP 312 using wireless communication. The AP 312 may be in communication with the Wi-Fi controller 314, which may further be in communication with the N3IWF 316. In an example, the Wi-Fi controller 314 may be a logical function that may be included in the LaaS system 320. Further, N3IWF 316 may include a load balancing function and thus, may balance network load between its interfaces with various 5G core nodes by using carrier aggregation. The N3IWF 316 may further be in communication with the UPF 318 via the N3 interface.

In both the embodiments, an instance of a user plane function (such as UPF 318) may be created in response to a service request by a user of the UE 302 or may be a default UPF. In an exemplary scenario, the instance of the UPF may be created depending on the resources requirements of an application selected by the user for execution on the UE 302. For instance, a latency-sensitive application demanding higher resources may have a separate UPF compared to an application that needs lesser resources. In this example, a MEC orchestrator, which may be included in the Edge site may control the creation of UPFs according to the application(s) selected on the UE 302.

Further, the created UPF 318 may be in communication with: the LaaS system 320 located on the edge site via N6 interface, the CU-UP 308 via the N3 interface, and another UPF 322 via the N9 interface. The UPF 322 may communicate with the one or more 5G core nodes 326 via the N4 interface and with the data network 324 via N6 interface.

In accordance with the embodiments of this disclosure, the LaaS system 320 may reside in an edge site of the communication network. In an embodiment, the LaaS system 320 may be designed to incorporate the functionalities of both RIC architecture 100 and MEC architecture 200 as illustrated previously in FIGS. 1 and 2 into the unified architecture in the LaaS system 320. In one example, the LaaS system 320 may be capable of receiving RAN information via the E2 interface from a node, such as gNB, as described earlier in this disclosure. Further, LaaS system 320 may also receive MEC information from a created instance of the UPF 318 via N6 interface. In one example, this information may include user or UE related data, as described earlier in this disclosure. The user or UE related data may include, but not limited to, specific application data or location data of each UE, such as UE 302, connected to the communication network. This data may be received from the Lounge-X™ application in the UE. For the sake of understanding, only nodes and interfaces suitable to understand the operating environment of Laas system 320 have been shown for exemplary purpose.

Further in an exemplary scenario, the RIC and the MEC functions in the LaaS system 320 may determine filtering policies and traffic rules to be applied on the respective data that both these modules receive. For instance, the unified architecture, in accordance with the embodiments of this disclosure, may determine filtering policies and traffic rules based on both the real-time network state information (e.g. telemetry data) and the UE related data. These policies and rules may enable the unified architecture to determine AI-based inferences to take decisions on controlling various network components to optimize network performance for the deployed applications.

For edge-based deployments, as depicted in FIG. 3, DU 306, CU-UP 308, CU-CP 310, N3IWF 316, UPF 318, and LaaS system 320 may be deployed on the edge-site. The edge-site may be on-premises or in a central office. Further, the one or more 5G core nodes 326 and the UPF 322 may be deployed either in a public or central cloud. However, a person skilled in the art would understand that any of the above components may also be present outside of the edge-site depending on the design requirements.

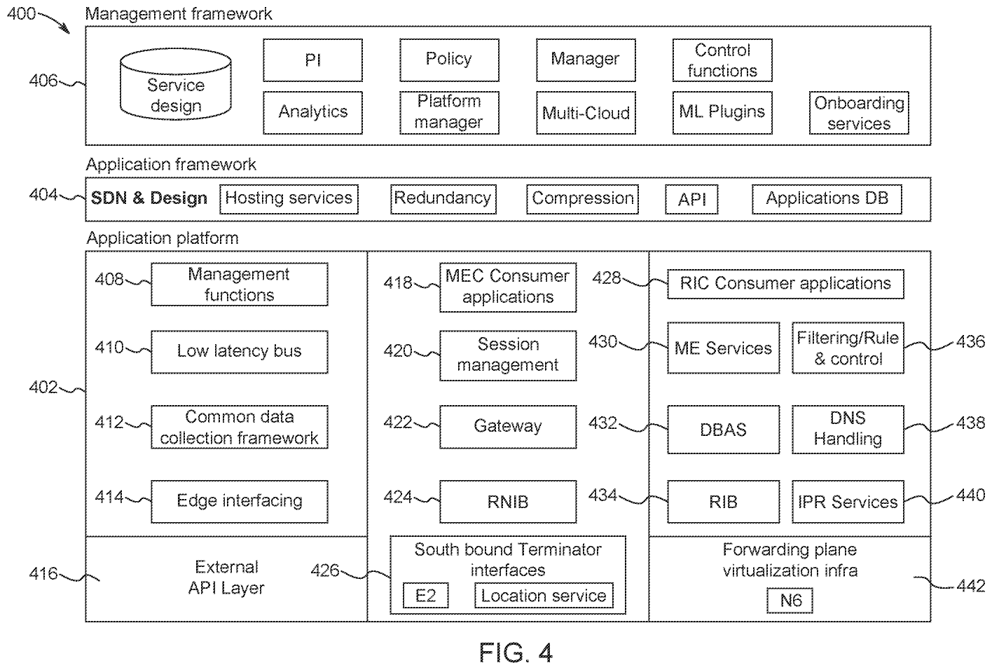

FIG. 4 depicts an exemplary LaaS architecture 400 in accordance with an embodiment. As depicted in FIG. 4, the LaaS architecture 400 may include three sections, namely an application platform 402, an application framework 404, and management framework 406.

The application platform 402 may include modules such as management functions 408, a low latency bus 410 to support communication between the MEC platform and the infrastructure controller, common data collection framework 412, edge interfacing 414, external API layer 416, MEC consumer applications 418, session management function 420, gateway 422, RNIB 424. The application platform 402 may further include southbound terminator interfaces 426 for E2 and Location services, RIC consumer applications 428, Managed element (ME) services 430, Database Administrators (DBAS) 432, Routing Information Base (RIB) 434, Filtering/Rules Control 436, Domain Name System (DNS) handling 438, Internet Protocol (IPR) services 440, and Forwarding Plane Virtualization Infra 442 for N6 interface.

Herein, the low latency bus 410 may support inter-communication in the LaaS system to achieve a predetermined end-to-end latency (e.g. low latency) for each application being executed on a user equipment (UE) connected to the communication network. Further, the application platform 402 is a unified platform which supports both RIC and MEC functionalities. The management functions 408 provide overall management of applications that are hosted on the application platform 402.

The application platform 402 may further include the common data collection framework 412, such that any type of data that is generated in any communication system such as the 4G/5G system, be it network data or resource data, can be collected, and provided to the required application that needs that data. Further, the application platform 402 may provide edge interfacing 414 functionality which allows any AI/Machine Learning (ML) based model to be hosted on the application platform 402. This may be considered as pushing a created or trained model to Edge. Edge interfacing 414 provides the application platform 402, the capability to connect with peripheral core network nodes and other applications on the edge. In some embodiments, the interfaces towards the edge node include N6 interface in the southbound terminator interfaces 426, towards UPF and E2 interface in the forwarding plane virtualization infrastructure 442 towards RAN node.

Further, MEC consumer applications 418 and RIC consumer applications 428 may be applications that are hosted over the application platform 402 (or MEC platform) to perform certain tasks. Such applications may be control plane or user plane applications. Additionally, the session Management function 420 may be used to manage the application session for both control plane and user plane applications. The Gateway 422 may be used to connect with an external network. In some embodiments, radio network information base (RNIB) 424 serves as a database to store radio network related information which is captured from the RAN. Southbound terminator interfaces 426 include an E2 interface terminator for RAN nodes and a location service terminator. In some embodiments, for edge-based deployments, location specific data of each UE connected to the communication network may be collected by the location service terminator. The location may be provided by GPS to the core network. In some embodiments, the degree of accuracy for each location may be 50-100 meters that may be achieved on MEC side for present networks.

In an exemplary scenario, a live event such as a football match may be conducted on-premises where a user is located, that is, in a stadium that may have Wi-Fi 6 and 5G network infrastructure for the user to view the streamed football content on the user's UE. The embodiments of this disclosure enable the user to view the streamed content without experiencing delays, as a consequence of the RIC and MEC integration by the unified RIC-MEC architecture. Additionally, load balancing techniques may be utilized in the unified RIC-MEC architecture for resource-intensive and latency-sensitive applications. Such load balancing techniques may, for instance, involve dynamic creation of application-specific slices depending on resource requirements of applications or distribution of traffic between both the Wi-Fi 6 and 5G network in scenarios where one network may not suffice for handling the entire traffic associated with an application.

Additionally, location specific sensors may be provided in the stadium so that every user may be specifically located/targeted, and a value-added or add-on service may be provided to the users based on their respective location. For example, local advertisements, pathways to other places etc. may be provided to such users based on the collected location data via the sensors.

Referring back to FIG. 4, ME services 430, as known in the art, are special services allocated for an edge, like Location based services, analytics services, etc. Further, filtering/Rules control 436 defines traffic rules or filtering policies to route traffic to appropriate MEC or RIC platform within the LaaS application platform 402. Once data reaches E2 interface or N6 interface or collected from location services, a forwarding plane which is common to both RIC and MEC applications may forward the received data or traffic to an appropriate destination based on the defined traffic rules or filtering policies.

Further, DNS handling 438 may be used to enable a DNS service on the application platform 402. The management framework 406 manages end-to-end service from both the RIC and MEC perspectives. Also, from the network core perspective, the management framework 406 may be capable to cater to the latency associated with application, such as AR/VR application.

Embodiments of LaaS architecture 400 are disclosed that are designed for latency-sensitive, computational and data-intensive services at the Edge of a network. Disclosed LaaS architecture 400 provides its effectiveness in terms of end-to-end service latency, which ensures a higher quality of service for end users. To this end, contextual information, and various latencies (i.e., data access latency, dynamic content latency, application, inference latency, computation latency, and network latency) may be considered to find an optimal service placement. Embodiments of an Edge Architecture framework are also disclosed that implements the proposed LaaS architecture.

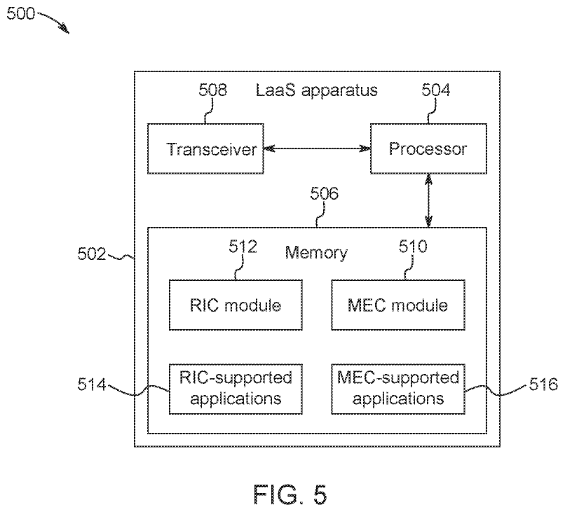

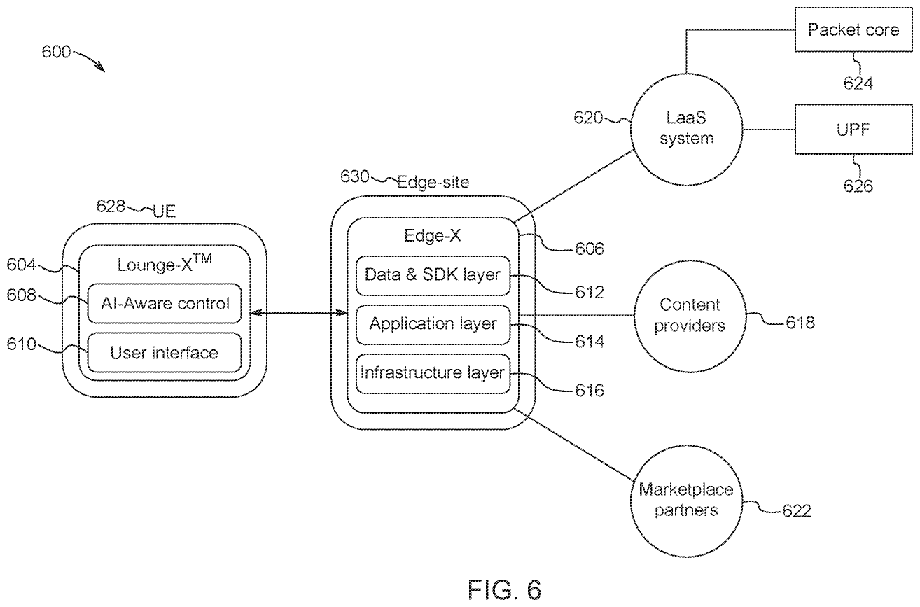

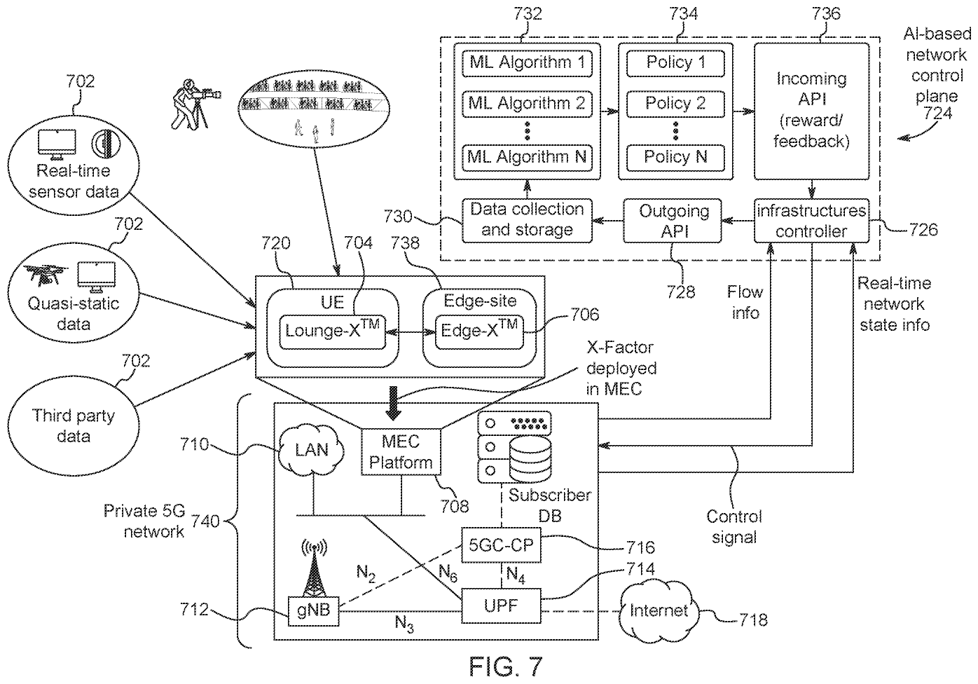

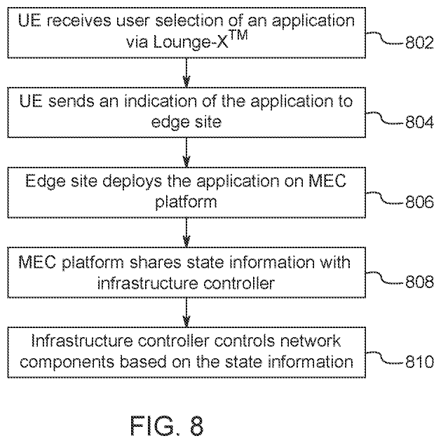

FIG. 5 shows an example implementation 500 of the LaaS system 502. In some embodiments, the LaaS system 502 may be similar or equivalent in functioning as the LaaS system 320, which is earlier discussed in the context of FIG. 3 of this disclosure. The LaaS apparatus 502 may include a unified architecture that includes a MEC platform and an infrastructure controller, as discussed in more detail, later, in the context of FIGS. 6 and 7. The LaaS apparatus 502 including the unified architecture may, in some embodiments, also perform all the steps as illustrated in FIG. 8 and described in more detail, later in this disclosure.

As shown in FIG. 5, the LaaS apparatus 502 structurally may include multiple functional modules to implement different functions in accordance with the embodiments of the present disclosure. In particular, the LaaS apparatus 502 may include, but not limited to, a processor 504, a memory 506, and a transceiver 508. The processor 504 may include suitable logic, circuitry, and/or interfaces that are operable to execute one or more computer-executable instructions stored in the memory 506 to perform pre-determined operations. The memory 506 may be operable to store one or more instructions.

In an example, as illustrated, the memory 506 may include, but not limited to, a MEC module 510, a RIC module 512, one or more RIC-supported applications 514, and one or more MEC-supported applications 516, which are configured to communicate with each other in accordance with the embodiments of this disclosure and to execute the above-described functionality.

Although FIG. 5 illustrates the RIC module 512 and RIC-supported applications 514 as separate modules, a skilled person would appreciate that RIC-supported applications 514 may or may not be included in the RIC module 512. Similarly, MEC-supported applications may or may not be included in the MEC module 510 (or MEC platform). Any subset of these modules may be implemented as a single module or separate modules. Additionally, the RIC module 512 may be synonymous with infrastructure controller 726 of FIG. 7 and the MEC module 510 may be synonymous with the MEC platform 708 of FIG. 7 in terms of their corresponding functions.

Alternately, the RIC module 512 may merely include the instructions to operate the infrastructure controller, which may itself be located outside the memory 506 and the MEC module 510 may similarly include the instructions to operate the MEC platform, which may be located outside the memory 506. Here, both the infrastructure controller and the MEC platform may be placed outside the memory 506 but within the LaaS apparatus 502.

The processor 504 may be implemented using one or more processor technologies known in the art. Examples of the processor 504 include, but are not limited to, an x86 processor, a RISC processor, an ASIC processor, a CISC processor, or any other processor. The transceiver 508 is communicatively coupled to the one or more processors. The transceiver 508 is configured to communicate with the various components of the communication network 300, as depicted in FIG. 3.

Further, the memory 506 may be designed based on some of the commonly known memory implementations that include, but are not limited to, a Random Access Memory (RAM), a Read Only Memory (ROM), a Hard Disk Drive (HDD), and a Secure Digital (SD) card. Further, the memory 506 includes the one or more instructions that are executable by the processor 504 to perform specific operations, as described above.

To improve network latency and its effectiveness, in the embodiments of this disclosure, the functions of Radio Access Network Intelligent Controller (near real-time RIC) can be performed by an infrastructure controller that is integrated along with MEC Platform. The infrastructure controller, although compliant with the Open RAN architecture, may perform additional functions such as Edge-based AI inferencing to intelligently control network infrastructure based on the real-time behavior of applications that are deployed on the MEC platform. This will enable applications to control all aspects of the 5G/Wi-Fi radio network namely: spectrum management, radio resource control, and bandwidth management. The integration of the infrastructure controller with MEC functions is expected to have low latency connectivity to many baseband units so that applications can provide a level of control spanning many separate radios, while still delivering the low latency needed to respond to near instantaneous changes in the mobile environment.

To improve the inference latency, depending on the context and scope of the requirement, associated data is needed at a high speed and low latency. In another scenario, aggregated and analyzed data, in the shape of actionable intelligence may be needed, enabling faster actions and decisions, whether made by human or not. In other words, one does not need all the data and its storage and analysis in the Cloud but only that bit of data traveling across the networks.

Using AI along with the radio information, the Quality of Service (QoS) can be guaranteed at User Equipment (UE) level and flow level to packet level at fine granularities. New network capabilities like location perception, link quality prediction etc. are achievable. Only relevant and required data for training the AI/ML model can be sent to the Cloud and the remaining data can be localized.

The disclosed LaaS architecture combines the capability of handling multiple aspects to accomplish ultra-low latency use-cases at the Edge. In an embodiment, the aspects include platform, applications, and system level Management & Orchestration (MEC). The aspects further include accessing network information by the infrastructure controller and providing inference at the Edge by using AI/ML algorithms. In the disclosed approach, single interface may be used to collect radio information as well as data plane traffic. The deployment of the disclosed architecture is convenient because RIC, MEC, and AI-based inference are integrated microservices. In an embodiment, the disclosed approach implements common functional blocks across RIC and MEC functions in the Open RAN network architecture and also helps in achieving RAN Slicing for various use-cases. For example, in the above example related to a football match in a stadium, different users may be provided different network slices depending on the application requirements that each user is using, as part of an application-aware network. This slicing in combination with the unified architecture as discussed in this disclosure, may ensure that ultra-low latency is achieved for such applications.

The disclosed LaaS platform architecture has numerous advantages. For example, LaaS architecture 400 provides better user experience optimization due to policy-driven closed loop automation and AI/ML. Herein, the terms “LaaS platform architecture” and “LaaS architectural framework” are interchangeably used. In an embodiment, the disclosed LaaS platform architecture 400 allows for increased optimizations through policy-driven closed loop automation and for faster, more flexible service deployments and program-abilities. In an embodiment, the disclosed LaaS architecture 400 also allows for more optimal resource allocation which will benefit the end users with better quality of service. In an embodiment, the disclosed LaaS architecture 400 demonstrates excellent interoperability with existing RIC platforms. The disclosed LaaS architecture 400 also has ease of deployment with single system rather than separate deployments of RIC & MEC, respectively.

The LaaS system or architecture framework as described in various embodiments has multiple use cases. Low latency scenarios may be handled at same place as the unified platform provided by the LaaS system enables user traffic as well as intelligent commands to be handled together. Therefore, latency is handled in a better way than in traditional systems where separate modules for RIC and MEC functionality were required.

FIG. 6 depicts a high-level illustration of a communication network 600, in accordance with the embodiments of this disclosure. The communication network 600 may include a user equipment (UE) 628, which may include the Lounge-X™ platform 604 installed on the UE 628, as an application as discussed earlier in this disclosure. In some embodiments, one or more latency-sensitive 5G applications installed on the UE 628 may be executed on the Lounge-X^{T}M platform 604.

Further, the UE 628 may be in communication with an edge site 630. In some embodiments, the edge site 630 may include, within its premises, edge site infrastructure provided by a third-party cloud provider. The edge site infrastructure may include several components to execute various functions of the edge site. In an exemplary scenario, the edge site 630 may include a data and Software Development Kit (SDK) layer 612, an application layer 614 and an infrastructure layer 616, the functions of which are known in the art and are not described here for the purposes of brevity. The edge site 630 may include fewer or additional components as per the design requirements of the edge site 630 according to the embodiments of this disclosure.

The edge site 630 or one or more of the above-mentioned components may be deployed on a third-party cloud and may be collectively referred to as Edge-X™ 606, in some embodiments. The edge site 630 or Edge-X™ 606 may, without limitation, refer to the same entity in some embodiments. However, in some other embodiments, the Edge-X™ 606 may be physically hosted on the edge site 630 and may include any of the components described above in the context of the edge site 630.

Further, the edge site 630 may be deployed in communication with the unified architecture as described earlier in this disclosure. Here, the unified architecture may be on the edge site 630 and may form a part of Edge-X™ 606. Alternately, the unified architecture may not necessarily be deployed on the edge site 630 and may be partially or completely located separately from the edge site. For instance, in one example the MEC platform 602 may be included in the edge site 630 while the infrastructure controller may be located externally to the edge site 630. In another example, both the MEC platform 602 and the infrastructure controller 602 may be located in a separate location than the edge site 630.

In the illustrated embodiment, the communication network 600 may include a LaaS system 620 that controls the functions of the communication network (e.g. a private 5G network) based on the applications deployed in the communication network. The LaaS system 620 may correspond to the LaaS system 320 of FIG. 3, in an embodiment. The LaaS system 620 may additionally include a MEC platform, an infrastructure controller, and a Wi-Fi controller. The functions of these entities may be similar to the corresponding entities described in the context of FIG. 3. Further, the LaaS system 620 may be in communication with a packet core 624 and a UPF 626.

In existing solutions both the RIC and the MEC platform operate as independent entities. The RIC does not have any view of the applications deployed on the MEC platform. Thus, the control of the network is not application aware. The embodiments of this disclosure enable the infrastructure controller to consider the real-time state information of applications deployed on the MEC platform and control the network components of the communication network 600 accordingly. Thus, the network is application aware, which enables the network to handle latency-sensitive applications in a more optimal manner depending on the applications that are deployed in the network.

Additionally, in some embodiments, the edge site 630 (or Edge-X™ 606) may be in communication with one or more content providers 618 to collect application-specific data on one or more latency-sensitive applications to better understand the latency requirements of the application. The application-specific data may be used to understand the resource requirements of the application and accordingly, create application-specific slices for resource allocation. The application specific slices may be deployed on the unified architecture, as described in the embodiments of the disclosure.

In some embodiments, the Edge-X™ 606 may also be in communication with one or more marketplace partners 622 for potential monetization opportunities. For instance, if a user is watching a football match in a stadium, the marketplace partners 622 may provide or more target advertisements embedded in the content being streamed on the UE 628.

FIG. 7 depicts a detailed illustration of a communication network 700, in accordance with an embodiment of this disclosure. In some embodiments, the communication network 700 may be considered as a more detailed illustration of the communication network 600 described in the context of FIG. 6. However, in some other embodiments, the communication network 700 may even be a different communication network from the communication network 600 without any dependency on FIG. 6.

The communication network may include a UE 720 which further includes a Lounge-X™ platform 704. Here, a user may select a latency-sensitive application on the UE 720 and the UE 720 may thus, receive the selection input from the user to execute that application using Lounge-X™ platform 704. The Lounge-X™ platform 704 may additionally receive data 702 such as real-time sensor data 702, quasi-static data 702, and third-party data 702 from various sources. This data may be used in the functions of the application and for communication with the Edge-X™.

In one example, the Lounge-X™ platform 704 may display several applications to the user on a display screen of the UE 720. The applications may be displayed once the user provides an input to the Lounge-X™ platform 704 via a “Lounge-X™” icon displayed on the UE 720. Once the Lounge-X™ 704 platform displays the associated applications, the user may be able to interact with the Lounge-X™ platform 704 and select one of the displayed applications, that the user intends to run/execute on the UE 720.

Further, the UE 720 may send an indication of the selected application to an edge site 738, which is in the highest proximity to the UE 720 among several edge sites located in proximity to the UE 720. In one example, the Lounge-X™ platform may be linked to an embedded subscriber identity module (eSIM) of the user, which may specify a set of latency-sensitive applications associated with the user. The eSIM may be used to authenticate the user with the network (e.g. Edge-X™) and subsequently, communicate with the network.

In an exemplary scenario, the edge site 738 may be selected based on additional criteria. For instance, the edge site 738 may also be selected based on one or more service level agreement (SLA) requirements to satisfy a particular application or use-case. In another exemplary scenario, the edge site 738 may be selected based on resource availability on that edge site 738. In yet another exemplary scenario, special hardware requirements of the application may also be taken into consideration to select an edge site 738 out of a plurality of edge sites.

In some embodiments, the Lounge-X™ and Edge-X™ 706 may be deployed in a MEC platform 708. The MEC platform 708 may be similar in functioning and capabilities as the MEC platform 602 of FIG. 6. However, the MEC platform 708 may have additional capabilities as well depending on the implementation requirements. Here, deploying the X-Factor™ may imply that the applications that are selected on the UE 720 are deployed on the MEC platform 708 by a MEC orchestrator (e.g. MEC orchestrator 222 of FIG. 2) present in the Edge-X™ 706.

Here, the MEC platform 708 may include, but not limited to, a MEC host that may physically host the applications, a MEC controller that may control the infrastructure of the MEC platform 708 and/or the edge site 738, and the MEC orchestrator that may determine deployment templates to deploy the applications in the MEC host. In some embodiments, the MEC platform 708 may be physically located on the edge site 738, which may further be hosted on a third-party cloud. Alternately, the MEC platform 708 may be located on a separate third-party cloud as compared to the location of the edge site 738, in some other embodiments.

The MEC platform 708 may further be in communication with a base station (gNodeB) 712 to enable the one or more UEs to access one or more user plane functions (UPFs) 714 corresponding to the applications being executed on the UEs, according to the embodiments of this disclosure. These UPFs may already be existing in the network or may be specifically created for the applications selected on the UE. In one example, the UPFs may be created by a virtualization infrastructure manager (not shown) that manages virtual infrastructure in a private network 740 (e.g. a private 5G network), which may be a part of the communication network 700. The application-specific UPFs that are created may then be deployed in the private network 740 such that a UE can access the UPFs to execute the applications selected on the UE. The aspect of creating separate UPFs for each application may also be referred to as application-specific network slicing within the scope of this disclosure.

The one or more UPFs 714 may be in communication with a 5G core control plane (5GC-CP) 716 via an N4 interface and with the MEC platform 708 via an N6 interface. A LAN interface 742 may connect the private network 740 to an external network. Further, the 5GC-CP 716 may be in communication with the gNodeB 712 via an N2 interface. The functions of the UPF 714 and the 5GC-CP 716 are similar to those of a user plane and control plane in 5G networks. Further, the 5GC-CP 716 may be in communication with a unified data management (UDM) subscriber database (DB) 744, which may store user data related to the users subscribed to the private network 740. The user data may include, but not limited to, user authentication data, user profiles, demographics and so on.

The private network 740 may be in communication with an Artificial Intelligence (AI)-based Network Control Plane 724, which may include, but not limited to an infrastructure controller 726, machine learning (ML) algorithms 1, 2, . . . N 732, policies 1, 2, . . . N 734, an incoming application programming interface (API) 736, an outgoing API 728, and a data collection and storage module 730. Here, the infrastructure controller 726 and the MEC platform 708 may collectively represent the LaaS system 320, in one example.

The infrastructure controller 726 may be in communication with the private network 740 to control various infrastructure components of the private network 740. In some embodiments, the MEC platform 708 may provide visibility to the infrastructure controller 726 to the applications deployed in the MEC platform 708 and their behavior. For instance, the MEC platform 708 may provide UE related data, real-time network state information, and/or flow information related to the private 5G network 740 to the infrastructure controller 726. The real-time state information and flow information may collectively be referred to as real-time information. In one example, the real-time network state information may include, but not limited to, information on the real-time state or functioning of the network once the application selected on the UE is deployed, real-time behavior of the applications deployed, real-time resource consumption by the application and any anomalies in the application behavior or network performance. Further, the flow information may include information related to an application being executed on the UE. For instance, the flow information may include one or more of, but not limited to, user related information (user profile, content being consumed using the application, monetary transactions made using the application etc.), real-time sensor data, location information of the UE, and information related to APIs being used by the application being executed on the UE.

On receiving the real-time information, the infrastructure controller 726 may forward this information to the outgoing API 728, which acts as an interface to the data collection and storage module 730 and forwards the real-time information to the data collection and storage module 730. Further, the AI-based network control plane 724 applies one or more of the ML algorithms 1, 2, . . . N to the real-time information in accordance with the policies 1, 2, . . . N that may be stored in the AI-based network control plane 724. Here, the ML algorithms 1, 2, . . . N may be stored in an ML algorithm module 732, which receives the real-time information from the data collection and storage module 730 and applies the ML algorithms to the real-time information. Further, the policies 1, 2, . . . N may each include a set of rules stored in the policy database 734. These policies may govern the manner in which the ML algorithms are selected by the ML algorithm module 732 to apply to the real-time information.

Once the ML algorithm module 732 applies the ML algorithms using the policies, it may output an AI-based inference to the infrastructure controller 726 through an incoming API. The AI-based inference may provide the infrastructure controller 726, a list of several potential actions that the infrastructure controller 726 can implement to control the infrastructure components of the private network 740. The infrastructure controller 726 may select one or more of the actions included in the AI-based inference.

Further, the infrastructure controller 726 may send a control signal to the private network 740 based on the selected action. The objective of the infrastructure controller 726 to send the control signal is to control the private network 740 in accordance with the real-time behavior of the applications deployed on the MEC platform 708 along with the UE related data. For example, the infrastructure controller 726 may take into account a network profile that indicates a real-time information on the behavior of a deployed application along with a user profile that indicates a user's content preferences, currently streamed application and/or current location. The infrastructure controller 726 may then arrive at a decision that that carrier aggregation needs to be deployed to increase an available bandwidth to support the currently streamed application. Optionally, the infrastructure controller 726 may control the one or more network components to switch to a different network to support the currently streamed application.

Here, the infrastructure controller 726 may include one or more of a 5G controller and a Wi-Fi controller. Regardless of the underlying radio access technology, the infrastructure controller 726 may control various radio components of the private network 740 at the radio layer of the private network 740. The radio layer may include one or more of the physical layer and the media access control (MAC) layer. The radio components may include, but not limited to, one or more radio units, one or more central units (CUs), and one or more distributed units (DUs).

In one example, the private network 740 may be a 5G network and the real-time information received by infrastructure controller 726 may indicate that the 5G network is experiencing heavy resource consumption because of several latency-sensitive applications deployed on the MEC platform 708. In such a scenario, the infrastructure controller 726 may control the 5G network components to reduce the resource consumption. For instance, the infrastructure controller 726 may connect the gNodeBs to different UPFs that may provide the UEs access to higher resources for the latency-sensitive applications.

Alternately, the infrastructure controller 726 may supplement the resources of the 5G network by aggregating bandwidth from a Wi-Fi 6 network that may be located on the same premises as the 5G network and/or the Edge-X™ 706. This link aggregation between the 5G and Wi-Fi 6 networks may provide a seamless and fluidic content viewing experience to a user who is consuming streaming content on the UE 720 by providing sufficient network infrastructure to support latency-sensitive applications.

In some embodiments, the functions performed by the AI-based Network Control Plane 724 may be performed by the infrastructure controller 726. In these embodiments, the AI-based Network Control Plane 724 may be integrated into the infrastructure controller 726.

Here, the infrastructure controller 726 may include a processor and a memory that stores computer-executable instructions. The computer-executable instructions, when executed, cause the processor to receive the real-time information related to the one or more applications deployed on the MEC platform 708 in the communication network 700. Further, the instructions cause the processor of the infrastructure controller 726 to control one or more infrastructure components of the communication network based on the received real-time information.

Here, the processor of the infrastructure controller 726, on receiving the real-time information, may determine one or more above-described algorithms 1, 2, . . . N, stored in the memory, in accordance with the one or more above-described policies 1, 2, . . . N that are stored in the memory. Further, the infrastructure controller 726 may apply the above-described ML algorithms to the real-time information to derive one or more AI inferences in a similar manner as described above. The AI inferences may indicate a list or set of one or more actions that the infrastructure controller 726 can take to control one or more infrastructure components of the private network 740 and/or the communication network 700.

The infrastructure controller 726 may, then select one of the actions depending on the real-time information, UE related data, and network requirements to deploy the latency-sensitive applications. The infrastructure controller 726 may, then send a control signal to one or more infrastructure components of the private network 740 and/or the communication network 700 to control the one or more infrastructure components of these networks. The infrastructure components have been described above and are not described again for conciseness and brevity.

FIG. 8 illustrates a flowchart for utilizing the unified architecture including the MEC platform and the interface controller, in accordance with the embodiments of this disclosure. The steps illustrated in this figure may be implemented in the manner described in the context of FIG. 7.

In step 802, a UE in a communication network receives a user selection of an application via Lounge-X™. In response to this user input, the UE may select the application for further execution. In step 804, the UE then sends an indication via the Lounge-X™ platform to an edge site in the communication network. The indication includes an indication of the selected application. On receiving the indication, the edge site may deploy the selected applications on the MEC platform in step 806.

In step 808, the MEC platform shares a real-time information related to the deployed applications and/or UE related data with an infrastructure controller in the manner described in the context of FIG. 7. In step 810, the infrastructure controller may control one or more infrastructure components of the communication network based on the state information, that is, based on the AI-based inferences derived on receiving that state information.

The terms “comprising,” “including,” and “having,” as used in the claim and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures, and techniques other than those specifically described herein can be applied to the practice of the invention as broadly disclosed herein without resort to undue experimentation. All art-known functional equivalents of methods, devices, device elements, materials, procedures, and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the LaaS platform/systems and methods described herein contain optional features that can be individually or together applied to any other embodiment shown or contemplated here to be mixed and matched with the features of that device. While the invention has been described with respect to a limited number of embodiments, those skilled in the art, having benefit of this disclosure, will appreciate that other embodiments can be devised which do not depart from the scope of the invention as disclosed herein.

I/We claim:

1. An infrastructure controller for handling latency-sensitive applications in a communication network, the infrastructure controller comprising:
a processor; and
a memory storing computer-executable instructions that when executed, cause the processor to:
receive a real-time information related to one or more applications deployed on a multi-edge computing (MEC) platform in the communication network; and
control one or more infrastructure components of the communication network based on the received real-time information.

2. The apparatus of claim 1, wherein the one or more applications are selected in response to a user input received by a user equipment (UE) connected to the communication network.

3. The apparatus of claim 1, wherein the computer-executable instructions further cause the processor to determine one or more machine learning (ML) algorithms to be applied on the received real-time information to derive one or more AI inferences.

4. The apparatus of claim 3, wherein the one or more AI inferences comprise one or more actions to control the one or more infrastructure components of the communication network based on the received real-time information.

5. The apparatus of claim 4, wherein the computer-executable instructions further cause the processor to:
receive a UE relate data;
select one of the one or more actions based on one or more of the received UE related data, received real-time information, and requirements of the communication network to deploy the one or more applications; and
send a control signal to the one or more infrastructure components to control the one or more infrastructure components based on the selected one or more actions.

6. The apparatus of claim 1, further comprising a low latency bus to support communication between the MEC platform and the infrastructure controller in the apparatus to achieve a predetermined end-to-end latency for each application being executed on a UE connected to the communication network.

7. The apparatus of claim 1, wherein the real-time information comprises one or more of a flow information and a network state information.

8. The apparatus of claim 1, wherein the one or more applications comprise one or more of an augmented reality (AR) application, a virtual reality (VR) application, a mixed reality (MR) application, a cloud gaming application, a video analytics application, a connected/autonomous vehicle related application, and an internet of things (IoTs) application.

9. The apparatus of claim 1, wherein the computer-executable instructions further cause the processor to store the real-time information in the memory.

10. The apparatus of claim 1, wherein the infrastructure controller and the MEC platform are located on an edge-site in the communication network.

11. A method for handling latency-sensitive applications in a communication network, the method comprising:
receiving, by an infrastructure controller, real-time information related to one or more applications deployed on a multi-edge computing (MEC) platform in the communication network; and
controlling, by the infrastructure controller, one or more infrastructure components of the communication network based on the received real-time information.

12. The method of claim 11, further comprising selecting the one or more applications in response to a user input received by a user equipment (UE) connected to the communication network.

13. The method of claim 11, further comprising determining one or more machine learning (ML) algorithms to be applied on the received real-time information to derive one or more AI inferences.

14. The method of claim 13, wherein the one or more AI inferences comprise one or more actions to control the one or more infrastructure components of the communication network based on the real-time information.

15. The method of claim 14, further comprising:
receiving a UE related data;
selecting one of the one or more actions based on one or more of the real-time information, received real-time information, and requirements of the communication network to deploy the one or more applications; and
sending a control signal to the one or more infrastructure components to control the one or more infrastructure components based on the selected one or more actions.

16. The method of claim 11, wherein the real-time information comprises one or more of a flow information and a network state information.

17. The method of claim 11, wherein the one or more applications comprise one or more of an augmented reality (AR) application, a virtual reality (VR) application, a mixed reality (MR) application, a cloud gaming application, a video analytics application, a connected/autonomous vehicle related application, and an internet of things (IoTs) application.

18. The apparatus of claim 11, further comprising storing the real-time information in a memory of the infrastructure controller.

19. The method of claim 11, wherein the infrastructure controller and the MEC platform are located on an edge-site in the communication network.

20. A computer-readable medium comprising computer-executable instructions that when executed by a processor, cause the processor to perform steps comprising:
receiving real-time information related to one or more applications deployed in a communication network; and
controlling one or more infrastructure components of the communication network based on the received real-time information.
